(19) United States
(12) Patent Application Publication
(10) Pub. No.: US 2002/0005416 A1
(43) Pub. Date: Jan. 17, 2002

(54) CELLULAR-WHEEL SLUICE WITH FAST-CHANGEABLE SEALING ARRANGEMENT

(76) Inventor: DIETER HEEP, BERGATREUTE (DE)

Correspondence Address: DANIEL DEJOSEPH, LEGAL DEPARTMENT, 2040 AVENUE C, BETHLEHEM, PA, 180172188

(21) Appl. No.: 08/963,056

(22) Filed: Nov. 3, 1997

(30) Foreign Application Priority Data
Nov. 1, 1996 (DE) 196 45 097.7

(51) Int. Cl. G01F 11/10

(52) U.S. Cl. 222/368

(57) ABSTRACT

The invention relates to a cellular-wheel sluice with a fast-changeable sealing arrangement for feeding bulk material into pneumatic feeding systems, in particular plastic granulate in dense-phase feeding systems, with feed pressures up to delta p which is equal to or less than 3 bar of overpressure, having closed cellular wheels, each comprising side disks disposed laterally on cellular-wheel struts in a side cap, into which disks a radially or axially acting sealing ring arrangement that follows the bending motion of the cellular wheel is integrated; a bearing arrangement for a cellular-wheel shaft and the side disk, which is split into at least two parts and communicates with the cellular wheel and the respective side cap and is embodied with a radial sealing arrangement, is disposed in each of the side caps.

### FIELD OF THE INVENTION

The invention relates to a cellular-wheel sluice of the type defined by the preamble to claim 1. Cellular-wheel sluices of this type are used to feed bulk material into pneumatic feeding systems, in particular plastic granulate in dense-phase feeding systems, with feed pressures up to delta p which is equal to or less than 3 bar of overpressure.

### BACKGROUND OF THE INVENTION

As a characteristic feature, they have closed cellular wheels, that is, laterally disposed side disks on the cellular-wheel struts, into which a radially or axially acting sealing arrangement is integrated.

To relieve the seal from sagging forces, for reasons of lengthening its service life, considerable efforts have been undertaken.

German Patent DE 40 19 628 C2 describes a version in which the sealing arrangement follows along with the bending motion of the cellular wheel, since the parts that together with the side disks of the cellular wheel form the sealing arrangement are rotatably supported on the shaft.

To an increasing extent, these cellular-wheel sluices are also being employed for abrasive products. This means that the sealing rings have to be changed at shorter intervals.

If so-called fast-cleaning versions are used in DE 40 196 28 for opening the sluice and removing the cellular wheel, then the two sealing arrangements remain in the assembled state. Not until the system is completely dismantled is it possible to gain access to the radial sealing rings. This is time-consuming and therefore can be done only after removing the cellular-wheel sluice on site and then transporting the remainder to a repair facility.

### OBJECT AND SUMMARY OF THE INVENTION

The object of the invention is to gain immediate access on site to the radial sealing ring, making its replacement a matter of minutes and so that the system can be maintained to prevent seal failure along the lines of the DIN standard 31051 on upkeep and kept ready for operation.

This object is attained by the characteristics of the body of claim 1.

An essential characteristic of the present invention is that now a cellular-wheel sluice is embodied with one side cap on the left and another on the right; the bearing arrangement for the cellular-wheel shaft is disposed in each side cap, and a side disk split into at least two parts is disposed in each side cap; the inner side disk is oriented toward the cellular wheel, and the other side disk is toward the respective side cap, and the radial sealing arrangement is disposed between the two side disks.

This has the essential advantage that this radial sealing arrangement is now especially easily accessible and thus is also embodied as easy to release. All that is now needed is to remove the respective side cap; together with the side cap, according to the invention, the side disk associated with the side cap is removed, because this side disk is connected to the side cap.

Now that the radial sealing arrangement is disposed in a space between the inner and outer side disks, this radial sealing arrangement is now especially easily accessible.

It does not matter, and both possibilities are covered by the scope of the present invention, whether the radial sealing arrangement remains on the inner side disk and is correspondingly easily accessible, or the radial sealing arrangement is oriented toward the outer side disk and can be moved together with the outer side disk and the side cap.

The nucleus of the invention is accordingly that the cellular wheel has at least two splittable side disks, which separate after being opened; the side disks that remain on the cellular wheel are supported via the shaft in the side cap, and the side disks that remain in the side cap are rotatably supported on their own hub, after the separation, the sealing ring is free on both sides for inspection and possible replacement.

In initial assembly, the separated side disks join together to form two units that rotate in common, and on the circumference they form the cavern for the sealing ring unit.

The bending compensation is assured since the theoretical center points shift toward one another during rotation on the common sealing O-rings.

This is understood to mean that the cellular-wheel shaft bends under stress. As a result, corresponding bending forces are also introduced to the radial sealing arrangement. By splitting the side disks into two parts, it is now attained that the inner side disk is always firmly joined to the cellular-wheel strut, and correspondingly goes along with the deforming work of the cellular wheel, while the outer side disk is joined to the side cap and correspondingly remains in position. Accordingly, the two side disks execute a certain displacement motion in the radial direction relative to one another, for instance by a distance of two-tenths of a millimeter.

It is preferred if this radial sealing arrangement comprises a multiple-part sealing ring, with which still other radial sealing rings are associated, namely preferably one further O-ring and a support ring belonging to it, these further rings being disposed at various radial spacings from the cellular-wheel shaft.

This entire sealing arrangement accordingly executes the above-described play of motion, and as a result adequate sealing is assured at all times under all loading states.

It is understood that the present invention is not limited to this type of seals as described; a stuffing box (packing ring) or a lip seal ring or other suitable kinds of seals may also be used. What is definitive is only the splitting of the side disk into at least one inner and one outer side disk, with the appropriate sealing arrangement disposed between the two side disks. This accordingly has the advantage—as noted above—that when the cap is removed, the outer side disk is removed along with the cap, and as a result the sealing arrangement disposed between the two side disks is then freely accessible and easy to replace.

The invention will now be described in further detail in conjunction with the drawings, which show merely one possible embodiment. Other characteristics essential to the invention and advantages of the invention will become apparent from the drawings and their description.

The subject of the present invention encompasses not merely the subject of the individual claims but also the combination of the individual claims with one another.

All the statements in specifications disclosed in the present text, including the abstract, and in particular the three-dimensional embodiment shown in the drawings, are claimed as essential to the invention to the extent that individually or in combination with one another they are novel over the prior art.

### BRIEF DESCRIPTION OF THE DRAWINGS

FIG. 1 is a section through the fixed bearing side of a cellular-wheel sluice according to the invention; and

FIG. 2 is a section through the drive bearing side of the same cellular-wheel sluice, showing it after the side cap has been partly removed.

### DESCRIPTION OF THE PREFERRED EMBODIMENT

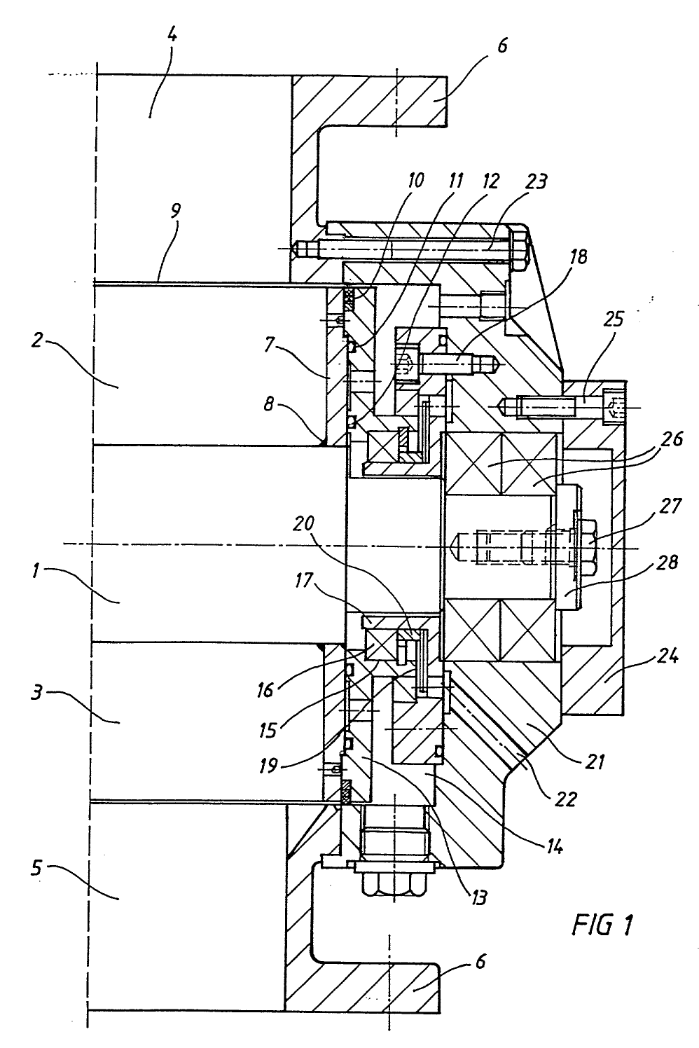

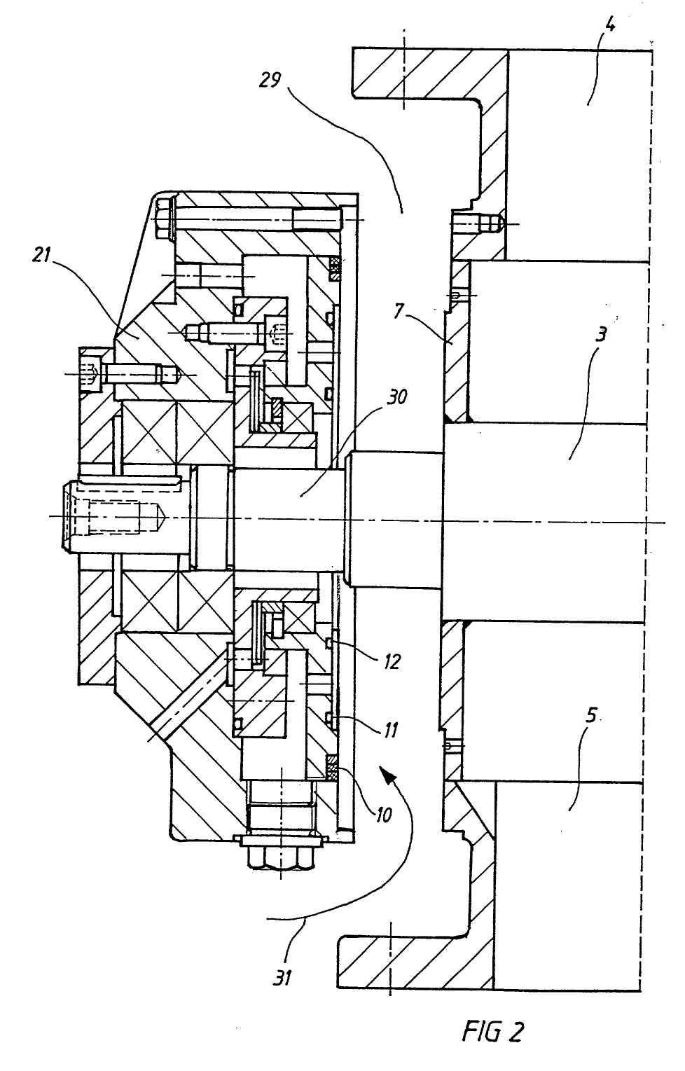

In FIGS. 1 and 2, the left and right sides of a cellular-wheel sluice are shown; in FIG. 2, not all the parts are designated because they have already been shown in FIG. 1 and described accordingly in the ensuing description.

In a manner known per se, a number of cellular-wheel struts 2, 3 are disposed on a cellular-wheel shaft 1 in a manner fixed against relative rotation; in combination with associated housing edges, they form a sealing gap 9. One housing flange 6 for an inlet 4 is disposed on top of the housing of the cellular-wheel sluice, and a further housing flange 6 for an outlet 5 is disposed on the underside.

An important feature is that an inner side disk 7 is connected via welded points 8 or other fastening means directly to the revolving part of the cellular-wheel sluice, such as the cellular-wheel shaft 1 or the cellular-wheel struts 2. Accordingly, the side disk 7 revolves with the cellular wheel.

By comparison, a side disk 13 rotatably supported on the side cap 21, in combination with the inner side disk 7, defines a radial sealing arrangement. This radial sealing arrangement comprises an outer multiple-part sealing ring 10, which preferably is a combination of one PTFE-compound ring, one O-ring and one metal support ring, an O-ring 11 located radially under it, and a further O-ring 12 located radially under O-ring 11.

The bearing of the outer side disk 13 is accomplished in such a way that it has an axial collar, on which a groove for receiving a bearing 16 is milled. This bearing 16 is axially prestressed by an axial ring 20 and a cup spring 19; the cup spring 19 is supported on one side on the ring 20 and on the other on a radial collar of a hub 17, which on the one hand carries the bearing 16 and on the other is secured by means of screws 18 to the side cap 21. The internal diameter of cup or disk spring 19 touches ring 20 and the external diameter touches disk 17, connected to side cap 21.

A conduit 22 extends through the side cap 21 as far as the interior of an inner hollow chamber 14 that is used for ventilation. The side cap 21 is releaseably secured to the housing flange 6 by means of screws 23 that are distributed uniformly on the circumference.

The side cap 21 also has an outer guard cap 24, which is secured to it by screws 25. The guard cap 24 supports the two support bearings 26, which are disposed between the side cap 21 and an associated collar 30 of the cellular-wheel shaft 1, and which are the main bearings which have to take the force of the conveying pressure against the star-valve.

The two support bearings 26 are axially prestressed by a screw 27 and an associated disk 28.

FIG. 2 shows the easy accessibility of the radial sealing arrangement 10, 11, 12. That is, if the screws 23 are undone, the entire side cap 21 can then be pulled off in the axial direction, in terms of FIG. 2, and removed from the collar 30 of the cellular-wheel shaft 1, thereby producing a relatively large free space 29, into which one can gain access in the direction of the arrow 31 to the seals 10, 11, 12 and easily replace them.

It is understood that the invention is not limited to this sealing arrangement 10, 11, 12; it may also be embodied differently.

It is equally possible for the entire sealing arrangement 10, 11, 12 to be disposed in the region on the inside of the side disk 7.

1. A cellular-wheel sluice with a fast-changeable sealing arrangement for feeding bulk material into pneumatic feeding systems, in particular plastic granulate in dense-phase feeding systems, with feed pressures up to delta p which is equal to or less than 3 bar of overpressure, having closed cellular wheels, each comprising side disks disposed laterally on cellular-wheel struts in a side cap, into which disks a radially or axially acting sealing ring arrangement that follows the bending motion of the cellular wheel is integrated, a bearing arrangement for a cellular-wheel shaft and the side disk, which is split into at least two parts and communicates with the cellular wheel and the respective side cap and is embodied with a sealing means, is disposed in each of the side caps.

2. The cellular-wheel sluice of claim 1, wherein the sealing means is a radial sealing arrangement.

3. The cellular-wheel sluice of claim 1, wherein the sealing means is a stuffing box.

4. The cellular-wheel sluice of claim 1, wherein the sealing means is a lip seal ring.

5. The cellular-wheel sluice of claim 1, wherein the inner side disk is connected directly via fastening means, for instance via welded points, to the revolving part of the cellular-wheel sluice, such as to the cellular-wheel shaft or the cellular-wheel struts.

6. The cellular-wheel sluice of claim 1, wherein at least two cellular-wheel struts are disposed in a manner fixed against relative rotation on the cellular-wheel shaft and in combination with associated housing edges form a sealing gap, wherein a housing flange for an inlet and a further housing flange for an outlet are disposed on the top of the cellular-wheel sluice housing and on the underside of the cellular-wheel sluice housing, respectively.

7. The cellular-wheel sluice of claim 6, wherein the inner side disk is connected directly via fastening means, for instance via welded points, to the revolving part of the cellular-wheel sluice, such as to the cellular-wheel shaft or the cellular-wheel struts.

8. The cellular-wheel sluice of claim 7, wherein the multiple-part radial sealing arrangement disposed removably between the inner and the outer side disks preferably comprises an outer multiple-part sealing ring, an O-ring located below it, and a further metal support ring located below that.

9. The cellular-wheel sluice of claim 1, wherein the outer side disk, for bearing purposes, has an axial collar with a milled groove for receiving a bearing, wherein the bearing is disposed, prestressed in the axial direction, by an axial ring and a cup spring, the cup spring being supported at one end on the ring and at the other on a radial collar of a hub, and the cup spring supporting the bearing and being secured to the side cap by means of screws.

10. The cellular-wheel sluice of claim 1, wherein a conduit extending into an inner hollow chamber and serving to provide ventilation is embodied in the side cap, the side cap being releaseably secured to the housing flange by means of screws distributed uniformly on the circumference.

11. The cellular-wheel sluice of claim 1, wherein the side cap has an outer guard cap, secured to it by screws, which supports the two support bearings that are disposed between the side cap and an associated collar of the cellular-wheel sluices and are prestressed in the axial direction by means of a screw and an associated disk.

12. The cellular-wheel sluice of claims 1, wherein, after axial removal of the side cap, a free space results, with the sealing means accessible in the direction of an arrow.

13. The cellular-wheel sluice of claim 1, wherein the sealing means is disposed in the region of the inner side disk.

14. A cellular-wheel sluice with a fast-changeable sealing arrangement for feeding bulk material into pneumatic feeding systems, in particular plastic granulate in dense-phase feeding systems, with feed pressures up to delta p which is equal to or less than 3 bar of overpressure, having closed cellular wheels, each comprising side disks disposed laterally on cellular-wheel struts in a side cap, into which disks a radially or axially acting sealing ring arrangement that follows the bending motion of the cellular wheel is integrated, wherein a bearing arrangement for a cellular-wheel shaft and the side disk, which is split into at least two parts and communicates with the cellular wheel and the respective side cap and is embodied with a radial sealing arrangement, is disposed in each of the side caps, wherein the first side disk is connected in a manner fixed against relative rotation to the shaft of the cellular-wheel sluice, and the two side disks are disposed such that they can execute a displacement motion relative to one another at least in the radial direction.
